(19) United States
(12) Patent Application Publication
(10) Pub. No.: US 2024/0227367 A9
(43) Pub. Date: Jul. 11, 2024

(54) APPLIED PAPER OVERLAY WITH IMPROVED ELASTICITY AND FLEXIBILITY FOR USE WITH ENGINEERED WOOD

(71) Applicant: LOUISIANA-PACIFIC CORPORATION, Nashville, TN (US)

(72) Inventor: ROBERT SKULEMOWSKI, LAKEWOOD, IL (US)

(21) Appl. No.: 18/383,823

(22) Filed: Oct. 25, 2023

Related U.S. Application Data
(60) Provisional application No. 63/419,013, filed on Oct. 25, 2022.

(51) Int. Cl. B32B 21/06; B32B 21/14; B32B 29/06; B32B 37/10

(52) U.S. Cl. CPC B32B 21/06; B32B 21/14; B32B 29/06; B32B 37/10; B32B 2250/02; B32B 2307/51; B32B 2307/546; B32B 2398/10

(57) ABSTRACT

A composite wood panel with an overlay made using a butylated (including, but not limited to, iso-butylated or n-butylated) melamine formaldehyde (BMF) resin cross-linking agent, substituting for or replacing some or all of the methylated melamine formaldehyde resin cross-linking agent. This results in a BMF-containing MF resin component that is more elastic and flexible, and provides those properties to paper overlays made with a BMF resin mixture (“BMF overlays”). BMF overlays applied to the surfaces of engineered wood panels or boards results in the reduction or elimination of the fissures produced during the pressing and production processes.

This application claims priority to and benefit of U.S. Provisional App. No. 63/419,013, filed Oct. 25, 2022, which is incorporated herein in its entirety by specific reference for all purposes.

### FIELD OF INVENTION

This invention relates to a system, product and process for manufacturing multi-layered engineered panels or boards with an applied paper overlay with improved elasticity and flexibility.

### BACKGROUND OF THE INVENTION

In general, wood-based composites include, but are not limited to, oriented strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildew-cides, insecticides, and water repellents. A significant advantage of strand and particle-based wood composites is that they have many of the properties of plywood and dimension lumber, but can be made from a variety of lower grade wood species, smaller trees and waste from other wood product processing. In addition, they can be formed into panels and boards in lengths and widths independent of the size of the harvested timber.

One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

One or more paper overlays are often applied to at least one surface of the panel, either during the primary pressing process or during a secondary pressing process. The paper overlay may be used with various form of panels and boards, including, but not limited to, structural panels, lap and panel siding, soffit, and trim. Overlays may provide a smoother surface for the final product, but also may provide protection from various environmental conditions, such as rain or weather.

Oriented, multilayer wood strand panels and similar products of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

### SUMMARY OF INVENTION

In various exemplary embodiments, the present invention comprises a paper overlay made using a butylated (including, but not limited to, iso-butylated or n-butylated) melamine formaldehyde (BMF) resin cross-linking agent, substituting for or replacing some or all of the methylated melamine formaldehyde resin cross-linking agent. In essence, butyl functional groups replace methyl functional groups.

In the present invention, the use of BMF resin in the melamine-formaldehyde resin component in the overlay production, the BMF resin replacing some or all of the methylated MF resin, results in a BMF-containing MF resin component (referred to hereinafter as a “BMF mixture”) that is more elastic and flexible than the prior art methylated MF resin component. These properties carry over to paper overlays made with a BMF mixture (“BMF overlays”). BMF overlays applied to the surfaces of engineered wood panels or boards results in the reduction or elimination of the fissures produced during the pressing and production processes. This improves the appearance and/or functionality of the finished panels and board with BMF overlays.

The amount of BMF resin used in the BMF mixture can vary from approximately 1% to 100% by weight, depending on a variety of factors, including, but not limited to, the particular type of composite wood product being made (e.g., oriented strand size, amount or thickness of any fines layer being used, thickness of the composite wood mat and/or final product, type of wood being used, and the like), production line factors (e.g., temperature of the press, amount of pressure applied by the press, time of pressing, number of overlays being applied, the type of paper used in the overlay, and the like), and the intended or desired use, including end-use, of the composite-wood product. The number and appearance of fissures produced in the same composite-wood product using the prior art melamine formaldehyde resin mixture also can be a factor in determining the amount of BMF to be used. Thus, for example, the BMF mixture may comprise approx. 50% BMF and approx. 50% methylated melamine formaldehyde resin, by weight. For overlays requiring greater flexibility to reduce or eliminate fissures, the BMF mixture may be approx. 51-100% BMF and approx. 0%-49% methylated melamine formaldehyde resin, by weight. For overlays requiring less flexibility to reduce or eliminate fissures, the BMF mixture may be approx. 1-49% BMF and approx. 51%-99% methylated melamine formaldehyde resin, by weight. As discussed above, the relative composition percentages to achieve the desired level of reduction or elimination of fissures in an overlay will depend on several factors.

### BRIEF DESCRIPTION OF THE DRAWINGS

FIG. 1 shows a diagram of a process for producing a composite wood strand product with an overlay comprising butylated melamine formaldehyde resin.

FIG. 2 shows a cross-section view of a composite wood strand product with an overlay comprising butylated melamine formaldehyde resin.

### DETAILED DESCRIPTION OF EXEMPLARY EMBODIMENTS

Paper overlays at present are made using methylated melamine formaldehyde resin as a cross-linking agent (e.g., HMMM, also known by the trade name of Cymel 303). Melamine formaldehyde resins, which comprise melamine rings terminated with multiple hydroxyl groups derived from formaldehyde, generally are hard and durable thermosetting resins. Melamine resins are methylated by adding excess methanol in the manufacturing process, resulting in the incorporation of methyl functional groups into the structure of the melamine formaldehyde (MF) polymer, resulting in increased stability. Methylated MF resins are used in a variety of processes and application, including cross-linking among diverse groups of polymers. For example, a fire resistant composition using methylated melamine formaldehyde resin as a binder precursor for an intumescent particle coating is disclosed in Winterowd, et al., U.S. Pat App. No. 20180030286 A1 (Feb. 1, 2018), which is incorporated herein in its entirety by specific reference for all purposes.

During application of a paper overlay with methylated MF to the surface of an engineered wood panel or board (including, but not limited to, a siding panel or board), fissures form in the paper overall during the pressing process. These fissures adversely affect the appearance and/or functionality of the finished product (i.e., the panel or board with overlay).

In various exemplary embodiments, the present invention comprises a composite wood product (e.g., panel, board made from composite or engineered wood, including, but not limited to, Oriented Strand Board) with a paper overlay made using a butylated (including, but not limited to, iso-butylated or n-butylated) melamine formaldehyde (BMF) resin cross-linking agent, substituting for or replacing some or all of the methylated melamine formaldehyde resin cross-linking agent. In essence, butyl functional groups replace methyl functional groups.

BMF resins are used in compositions to provide coatings and the like in various industries, including coatings for the automobile and truck manufacturing industry, Irvin, et al., U.S. Pat. No. 3,901,840, issued Aug. 26, 1975; undercoat layers for photoconductors, see Wu, et al., U.S. Pat. No. 8,227,154, issued Jul. 24, 2012; protective coatings for window glass, see Baikerikar, et al., U.S. Pat. No. 8,147,974, issued Apr. 3, 2012; and the polymeric fine fiber industry, see Shenoy, et al., U.S. Pat. App. Pub. 20170157543 A1, published Jun. 8, 2017; all of which are incorporated herein in their entireties by specific reference for all purposes.

In the present invention, the use of BMF resin in the melamine-formaldehyde resin component in the overlay production, the BMF resin replacing some or all of the methylated MF resin, results in a BMF-containing MF resin component (referred to hereinafter as a “BMF mixture”) that is more elastic and flexible than the prior art methylated MF resin component. These properties carry over to paper overlays made with a BMF mixture (“BMF overlays”). BMF overlays applied to the surfaces of engineered wood panels or boards results in the reduction or elimination of the fissures produced during the pressing and production processes. This improves the appearance and/or functionality of the finished panels and board with BMF overlays.

The amount of BMF resin used in the BMF mixture can vary from approximately 1% to 100% by weight, depending on a variety of factors, including, but not limited to, the particular type of composite wood product being made (e.g., oriented strand size, amount or thickness of any fines layer being used, thickness of the composite wood mat and/or final product, type of wood being used, and the like), production line factors (e.g., temperature of the press, amount of pressure applied by the press, time of pressing, number of overlays being applied, the type of paper used in the overlay, and the like), and the intended or desired use, including end-use, of the composite-wood product. The number and appearance of fissures produced in the same composite-wood product using the prior art melamine formaldehyde resin mixture also can be a factor in determining the amount of BMF to be used. Thus, for example, the BMF mixture may comprise approx. 50% BMF and approx. 50% methylated melamine formaldehyde resin, by weight. For overlays requiring greater flexibility to reduce or eliminate fissures, the BMF mixture may be approx. 51-100% BMF and approx. 0%-49% methylated melamine formaldehyde resin, by weight. For overlays requiring less flexibility to reduce or eliminate fissures, the BMF mixture may be approx. 1-49% BMF and approx. 51%-99% methylated melamine formaldehyde resin, by weight. As discussed above, the relative composition percentages to achieve the desired level of reduction or elimination of fissures in an overlay will depend on several factors.

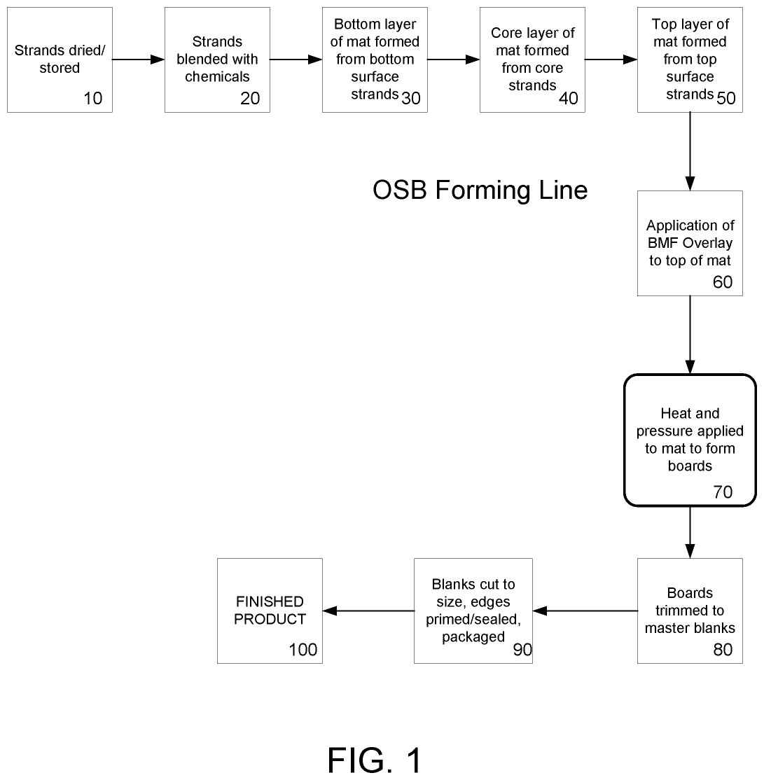

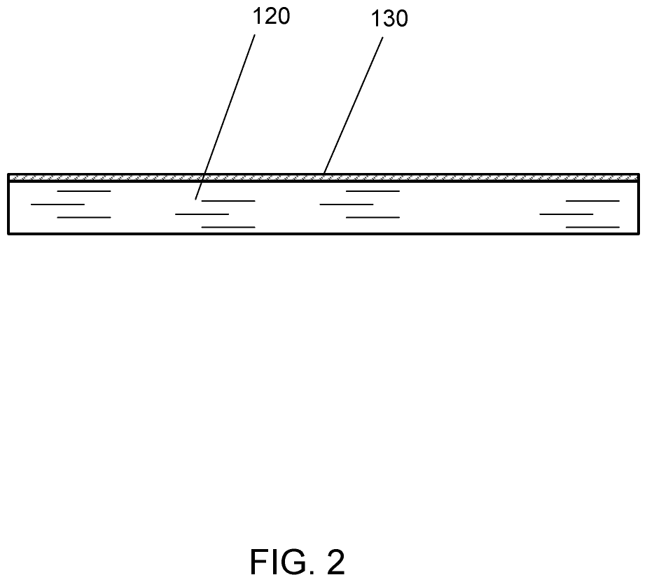

FIG. 1 shows a manufacturing process for an OSB engineered-wood product with a BMF overlay. Steps include the producing, drying and storing of wood strands 10, the treatment or blending of designated strands (e.g., bottom, core, top) with applicable chemicals and/or additives (e.g., wax, resin, and the like) 30, the forming of the appropriate layers in order (first bottom surface, then core, then top surface) using designated strands, 30, 40, 50, the application of a BMF overlay to the top of the mat (i.e., to the upper surface of the top layer) 60, the application of heat and pressure to the mat using a primary press to form boards 70, and subsequent trimming 80 and processing (e.g., panels cut to size, edges primed/sealed, and packaging) 90 to produce the finished product 100. Strands for a particular layer typically are blended with applicable chemicals and/or additives in a bin, separate from strands for other layers, although this is not always the case. FIG. 2 shows a cross-section view (not to scale) of an exemplary composite-wood panel produced by the method of FIG. 1. The BMF overlay 130 is affixed to a surface of the multi-layered composite wood substrate 120.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A composite wood product, comprising:
a multiple-layer substrate comprising wood strands, said substrate comprising an upper face;
an overlay affixed to the upper face, said overlay comprising a melamine-formaldehyde resin component;
wherein the melamine-formaldehyde resin component comprises butylated melamine-formaldehyde resin.

2. The product of claim 1, wherein the melamine-formaldehyde resin component does not comprise methylated melamine-formaldehyde resin.

3. The product of claim 1, wherein the melamine-formaldehyde resin component comprises 100% butylated melamine-formaldehyde resin.

4. The product of claim 1, wherein the melamine-formaldehyde resin component comprises approximately 1% to approximately 10% butylated melamine-formaldehyde resin.

5. The product of claim 1, wherein the melamine-formaldehyde resin component comprises approximately 10% butylated melamine-formaldehyde resin.

6. The product of claim 1, wherein the melamine-formaldehyde resin component comprises approximately 10% to approximately 25% butylated melamine-formaldehyde resin.

7. The product of claim 1, wherein the melamine-formaldehyde resin component comprises approximately 25% to approximately 50% butylated melamine-formaldehyde resin.

8. The product of claim 1, wherein the melamine-formaldehyde resin component comprises approximately 50% to approximately 100% butylated melamine-formaldehyde resin.

9. The product of claim 1, wherein the melamine-formaldehyde resin component comprises approximately 50% to approximately 75% butylated melamine-formaldehyde resin.

10. The product of claim 1, wherein the melamine-formaldehyde resin component comprises approximately 75% to approximately 100% butylated melamine-formaldehyde resin.

11. The product of claim 1, wherein the melamine-formaldehyde resin component comprises approximately 50% butylated melamine-formaldehyde resin and 50% methylated melamine-formaldehyde resin.

12. The product of claim 1, wherein the melamine-formaldehyde resin component further comprises methylated melamine-formaldehyde resin.

13. The product of claim 12, wherein the melamine-formaldehyde resin component is a combination of said butylated melamine-formaldehyde resin and methylated melamine-formaldehyde resin, wherein the percentage amount of each sum to 100%.

14. The product of claim 1, wherein the overlay is a paper overlay.

15. The product of claim 1, wherein the overlay is not fissured.
